(19) United States
(12) Patent Application Publication
(10) Pub. No.: US 2005/0218793 A1
(43) Pub. Date: Oct. 6, 2005

(54) Single crystal electro-optic film on silicon imager

(76) Inventors: Achintya K. Bhowmik, San Jose, CA (US); Shida Tan, San Jose, CA (US)

Correspondence Address: TROP PRUNER & HU, PC, 8554 KATY FREEWAY, SUITE 100, HOUSTON, TX, 77024, US

(21) Appl. No.: 10/814,402

(22) Filed: Mar. 31, 2004

(51) Int. Cl. H05B 33/14

(52) U.S. Cl. 313/504; 313/503

(57) ABSTRACT

A single crystal electro-optic film on silicon imager may be utilized for a projection display system. The imager may use a film exhibiting a second order non-linear electro-optic effect. Unlike conventional liquid crystal on silicon systems, the single crystal electro-optic film may have much higher modulation rates.

### BACKGROUND

This invention relates generally to imagers for display applications.

High end large screen rear projection high definition televisions are one potential application for microdisplay imagers. Another application area is in front projection systems for home theaters or business uses. In a projection display system, the imager produces the image that appears on the display.

A liquid crystal on silicon panel may convert digital data corresponding to a video frame into a picture display. The panel may control the gray level of reflected light from the panel by varying the level of voltage applied to the liquid crystal in each pixel in an analog drive scheme or the duration of the maximum applied voltage in a pulse-width modulated digital drive scheme.

Liquid crystal on silicon panels offer a number of superior performance advantages over competing technologies such as digital light processors. Since the drive transistors and the liquid crystal material are built on the same silicon substrate, considerable economies may be achieved.

However, the slow orientation process of the liquid crystal molecules in response to an applied voltage limits the switching speeds that are achievable. The slower switching speed is particularly an issue for high speed display applications including large screen rear projection high definition television display applications utilizing one or two imagers in a color-field sequential approach.

Thus, there is a need to provide techniques capable of switching speeds compatible with higher speed display applications.

### BRIEF DESCRIPTION OF THE DRAWINGS

FIG. 1 is an enlarged, side view of one embodiment of the present invention; and

FIG. 2 is a depiction of one embodiment of a display using the embodiment shown in FIG. 1.

### DETAILED DESCRIPTION

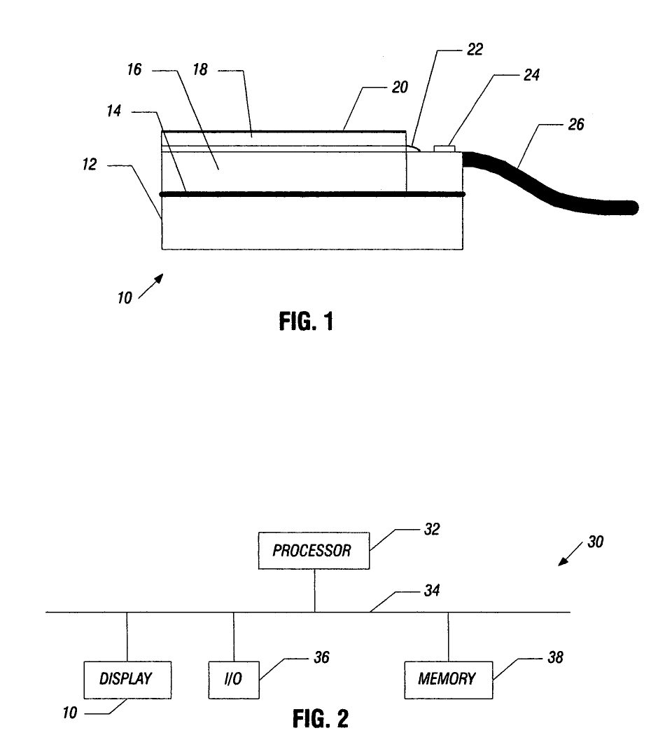

Referring to FIG. 1, a display 10 may be used in front projectors, rear projection televisions, and near-to-eye viewers found in cameras and video headsets, to mention a few examples. The display 10 may be a microdisplay that produces an image that is magnified for viewing in one embodiment.

A substrate 12 may be a ceramic substrate, in one embodiment, for thermal management and mechanical assembly. A thermal interface material 14 may be positioned between the silicon back plane 16 and the substrate 12. The thermal interface material 14 compensates for the differences in thermal expansion coefficients of the joined materials and facilitates heat dissipation from the backplane.

The silicon back plane 16 may include integrated components, such as drive transistors and frame buffer memory cells, formed within the substrate 16. Conventional semiconductor fabrication techniques may be utilized to form these components.

A number of wire bonds 22 may be formed from the back plane 16 to the conducting pads on the ceramic substrate 12 to transmit electrical drive signals to the pixels. The single crystal film 18 may be formed of an electro-optic material with appropriate principal axes orientation. A transparent top electrode 20 may be formed over the film. For example, the electrode 20 may be formed of indium tin oxide.

The film 18 may be a solid crystalline film that exhibits second order electro-optic effects. In some embodiments, the film 18 may provide higher switching speed display capabilities, while retaining competitive advantages associated with liquid crystal on silicon technology.

The silicon back plane 16 may include integrated transistors to drive each pixel in the imager 10, as well as integrated memory cells to serve as frame buffers. A single crystal solid thin film 18 of appropriate second order non-linear optical material may be deposited on the back plane 16 to serve as an electro-optically active layer. A layer of a transparent electrode 20, such as indium tin oxide, may be coated on the single crystal film 18 to serve as a top electrode in one embodiment.

When an electric field is applied to the electro-optically active single crystal film 18, its refractive index may be modified due to second order hyper-polarizability of the medium. This change in refractive index may result in changing the phase of the reflected light from the imager 10, traversing the film 18, according to the following formula:

$$Δ ϕ = \frac{2 π}{λ} {n}^{3} rEt$$

where λ is the optical wavelength, n is the refractive index of the medium in the absence of a field, r is the electro-optic coefficient of a single crystal film, E is the applied electric field, and t is the thickness of the film. With an incident light that is linearly polarized at 45 degrees to the principal axis of the single crystal film, a complete polarization conversion may be achieved when the field-induced relative phase change, for the optical waves polarized along the dipole axis and perpendicular to it, equals π.

The film 18, in one embodiment, may be a single crystal film of stilbene-based organic molecular salts, such as 4′-dimethylamino-N-methyl-4-stilbazolium tosylate (DAST). DAST possesses extremely large electro-optic coefficients and exhibits controlled crystalline film growth on planar substrates.

Since the origin of field-induced modification of the refractive index of the film 18 is electronic, relatively high switching speeds are possible. In contrast, the mechanism of polarization conversion in a liquid crystal on silicon panel is physical reorientation of the liquid crystal molecules in response to the field. Liquid crystal on silicon panels may have a speed of operation that may be limited to about one kilohertz, while field-induced modification of refractive index may achieve light modulation speeds greater than 100 gigaHertz.

The thickness of the electro-optically active film 18 may be controlled through a combination of crystal growth and chemical mechanical polishing techniques. This control removes the need for pillars or spacer beads used in liquid crystal panels that often result in artifacts in the resulting image. Also, the use of a solid, active material for light modulation may reduce the long-term reliability problems encountered with physical orientation of molecules in liquid crystal-based devices.

Referring to FIG. 2, a system 30 may utilize a display 10 of the type shown in FIG. 1. The system 30 may be a computer system, it may be a television system, or it may be any of a variety of other displays. For example, it may be a high end, large screen rear projection high definition television.

The system 30 includes a processor 32 coupled to a bus 34. The bus 34 is coupled to the display 10, an input/output device 36, and a memory 38.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
displaying an image using a second order non-linear electro-optic effect.

2. The method of claim 1 including forming an imager for a high end large screen rear projection high definition television.

3. The method of claim 1 including forming an imager for a front-projection system.

4. The method of claim 1 including forming a second order non-linear electro-optic film over a substrate.

5. The method of claim 4 including forming transistors in said substrate.

6. The method of claim 5 wherein forming transistors includes forming memory transistors and drive transistors in said substrate.

7. The method of claim 2 including forming a thermal interface material over a support structure and forming said substrate over said thermal interface material.

8. The method of claim 7 including forming said film of a second order electro-optic material having a switching speed on the order of at least one gigaHertz.

9. The method of claim 8 including forming said film of an electro-optic material having a switching speed of greater than 100 gigaHertz.

10. The method of claim 9 including forming said film of a stilbene-based organic molecular salt.

11. The method of claim 10 including forming said film of 4′-dimethylamino-N-methyl-4-stilbazolium tosylate.

12. An imager comprising:
a second order non-linear electro-optic film.

13. The imager of claim 12 including a support structure covered by a thermal interface material and a substrate over said support structure.

14. The imager of claim 13 including transistors formed in said substrate.

15. The imager of claim 14 including drive transistors and memory transistors in said substrate.

16. The imager of claim 12 wherein said film has a switching speed of at least one gigaHertz.

17. The imager of claim 16 wherein said film has a switching speed of greater than 100 gigaHertz.

18. The imager of claim 12 wherein said film includes a stilbene-based organic molecular salt.

19. The imager of claim 18 wherein said film includes 4′-dimethylamino-N-methyl-4-stilbazolium tosylate.

20. A system comprising:
a processor; and
an imager coupled to said processor, said imager including a second order non-linear electro-optic effect film.

21. The system of claim 20 including a support structure covered by a thermal interface material and a substrate over said support structure.

22. The system of claim 21 including transistors formed in said substrate.

23. The system of claim 22 including drive transistors and memory transistors in said substrate.

24. The system of claim 20 wherein said film has a switching speed of at least one gigaHertz.

25. The system of claim 24 wherein said film has a switching speed of greater than 100 gigaHertz.

26. The system of claim 20 wherein said film includes a stilbene-based organic molecular salt.

27. The system of claim 26 wherein said film includes 4′-dimethylamino-N-methyl-4-stilbazolium tosylate.

28. The system of claim 19 wherein in said system includes a front projection display system.
